(19) United States
(12) Patent Application Publication
(10) Pub. No.: US 2016/0173951 A1
(43) Pub. Date: Jun. 16, 2016

(54) REAL ESTATE TELEVISION SHOW FORMAT AND A SYSTEM FOR INTERACTIVELY PARTICIPATING IN A TELEVISION SHOW

(71) Applicant: John Raymond Nettleton RUDDICK, North Sydney, New South Wales (AU)

(72) Inventor: John Raymond Nettleton RUDDICK, North Sydney, New South Wales (AU)

(21) Appl. No.: 14/903,972

(22) PCT Filed: Jul. 8, 2014
(86) PCT No.: PCT/AU2014/000696

§ 371 Date: Jan. 8, 2016

(30) Foreign Application Priority Data
Jul. 8, 2013 (AU) 2013902515

(51) Int. Cl. H04N 21/478; G06Q 50/16; H04N 21/488; H04N 21/458; H04N 21/262; G06Q 30/06; G06Q 30/08

(52) U.S. Cl. CPC H04N 21/47815; G06Q 30/0641; G06Q 50/167; G06Q 30/08; H04N 21/458; H04N 21/262; H04N 21/4886

(57) ABSTRACT

A method of providing a show format includes providing a listing of a predetermined number of properties on the market that are scheduled to have a public inspection time over a predetermined period, the listing beginning with the least expensive featured property and ending with the most expensive featured property.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention generally relates to a real estate television show format and a system for interactively participating in a television show.

2. Description of Related Art Including Information Disclosed Under 37 CFR 1.97 and 37 CFR 1.98.

Real estate is a very competitive industry with a multitude of properties available for sale or lease (rent/let) represented by many different agents. There is a desire to provide a more appealing format for presenting properties to the public to increase interest and the number of visitors to properties which are open for inspection or scheduled for auction.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a show format comprising a listing of a predetermined number of properties on the market that are scheduled to have a public inspection time over a predetermined period, the listing beginning with the least expensive featured property and ending with the most expensive featured property.

In a preferred embodiment, the listing is a countdown of ‘x’ number of properties beginning with the least expensive featured property designated as ‘property number x’ in the countdown and ending with the most expensive featured property as ‘property number 1’.

In a preferred embodiment, the show format is broadcast via at least one of television, radio, telephone network, wireless network or the internet.

In a preferred embodiment, the properties are real estate properties.

In a preferred embodiment, the real estate properties are on the market for at least one of priced for sale, auction or lease.

In another preferred embodiment, the properties are at least one of commercial properties, vehicles, fashion items, furniture and antique items.

In a preferred embodiment, the predetermined number of properties is one of at least 10, at least 30, at least 50 and at least 70.

In another preferred embodiment, the predetermined number of properties is at least 100.

In a preferred embodiment, the public inspection time is an open for inspection time for the property.

In a preferred embodiment, the predetermined period is a time section of a day.

In a preferred embodiment, the time section is between 8 am and 4 pm.

In another preferred embodiment, the predetermined period is one day.

In another preferred embodiment, the predetermined period is one weekend.

In another preferred embodiment, the predetermined period is consecutive days of the week.

In another preferred embodiment, the consecutive days of the week are weekdays.

In another preferred embodiment, the predetermined period is the day on which the show is broadcast.

In another preferred embodiment, the predetermined period is the following day on which the show is broadcast.

In a preferred embodiment, each featured property is provided an allocated time slot to show the property.

In a preferred embodiment, the allocated time slot for each property is at least 30 seconds each.

In a preferred embodiment, the allocated time slot for more expensive properties is greater than less expensive properties.

In another preferred embodiment, the properties in the listing are real estate properties on the market for sale or auction and the show format comprises a news ticker listing property auction times for the predetermined period.

In a preferred embodiment, the properties in the listing are real estate properties on the market for sale or auction and the show format comprises a news ticker listing property open for inspection times for the predetermined period.

In a preferred embodiment, the properties in the listing are real estate properties and in the allocated time slot for each of property, there will be displayed on the screen information on the property comprising one or more of photos of the property, the address, the price guide, a video of the property, the time of the ‘Open for Inspection’, the name and contact details of the real estate agent, a photo or video of the real estate agent, the expected rental return, auction date, property trends in that suburb and other relevant facts.

In a preferred embodiment, the properties in the listing are real estate properties and the information shown for each property comprises a standard set of facts presented as text, graphics or a combination of both which includes property address, property type, number of bedrooms, bathrooms and car parking spaces and the price guide.

In a preferred embodiment, the show format will mention properties schedule for auction that day that were featured in a previous show.

In a preferred embodiment, the show will air early in the morning of the predetermined period.

In another preferred embodiment, the show will air during primetime or a later timeslot of the night before the predetermined period.

In a preferred embodiment, the show comprises a host and at least one expert panelist.

In a preferred embodiment, the show comprises at least two expert panelists each covering a set number of properties.

In a preferred embodiment, wherein the show comprises at least four expert panelists each covering 25 properties.

In a preferred embodiment, the host and at least one panellist will mention highlights of each property.

In a preferred embodiment, prior to property number 1, the show format will display the entire list from property number x to property number 2 in a rolling screen format with basic details for each property.

In a preferred embodiment, the show is located at the number 1featured property.

In a preferred embodiment, the countdown is sectioned into price bands of open for inspection properties being displayed together and the show format will display properties in each respective price band scheduled for auction in the predetermined period.

In a preferred embodiment, the show format comprises a presentation from a guest in the industry being at least one of a mortgage broker, a legal professional, an economist, a real estate developer, an accountant, an auctioneer, a builder, an architect, an interior designer and a trend analyst reporter.

In a preferred embodiment, the show format is limited to real estate properties having their first open for inspection in the predetermined period.

In a preferred embodiment, the show format is limited to real estate properties in a specific geographical market.

The present invention in another aspect provides a mobile device application software for providing information on a property shown in the show format according to any one of the above, the application software comprising:
means for a user to enter a property identification means of a selected property into the application software; and
wherein the application software provides information on the selected property.

In a preferred embodiment, show format is a countdown and the property identification means comprises the position number of the selected property in the countdown.

In a preferred embodiment, the application software provides a list of open for inspection selected properties.

In a preferred embodiment, the application software provides a list of selected properties scheduled for auction in the predetermined period.

In a preferred embodiment, the software can run in real time with the show format, and the property identification means comprises a button with a select function which can be actuated by the user.

In a preferred embodiment, the application software provides an itinerary schedule for viewing the properties in the list.

In a preferred embodiment, the application software provides a means for contacting the selling agent of the selected property.

The present invention in another aspect provides a mobile device comprising:
a processor for processing digital data;
a memory device for storing digital data including user configurable data representing at least one user configurable datum and computer program code, the memory device being coupled to the processor;
a user interface coupled to the processor,
wherein the processor is controlled by the computer program code to:
   allow a user via the user interface to enter a property identification means of a selected property shown in the show format according to any one of the above; and
   wherein the processor provides information on the selected property to the user interface.

In a preferred embodiment, the show format is a countdown and wherein the processor is further controlled by the computer program code to allow the user to enter the property identification means as being the position number of the selected property in the countdown.

In a preferred embodiment, the processor is further controlled by the computer program code to provide a list of open for inspection selected properties.

In a preferred embodiment, the processor is further controlled by the computer program code to provide a list of selected properties scheduled for auction in the predetermined period.

In a preferred embodiment, the processor is further controlled by the computer program code to provide an itinerary schedule for viewing the properties in the list.

In a preferred embodiment, processor is further controlled by the computer program code to provide a means for contacting the selling agent of the selected property.

The present invention in another aspect provides a computer readable storage medium for providing information on a property shown in the show format according to any one of the above, the computer readable storage medium comprising computer code instructions executable by a processor and comprising instructions for:
allowing a user via a user interface to enter a property identification means of a selected property shown in the show format; and
providing information on the selected property to the user interface.

In a preferred embodiment, the show format is a countdown and further comprising instructions for allowing the user to enter the property identification means as being the position number of the selected property in the countdown.

In a preferred embodiment, the computer readable storage medium further comprises instructions for providing a list of open for inspection selected properties.

In a preferred embodiment, the computer readable storage medium further comprises instructions for providing a list of selected properties scheduled for auction in the predetermined period.

In a preferred embodiment, the computer readable storage medium further comprises instructions for providing an itinerary schedule for viewing the properties in the list.

In a preferred embodiment, the computer readable storage medium further comprises instructions for providing a means for contacting the selling agent of the selected property.

The present invention in another aspect provides a system for interactively participating in a television program, comprising: a television show format according to any one of the above and a mobile device application software according to any one of the above.

The present invention in another aspect provides a method of interactively participating in a television program, comprising: a television show format according to any one of the above and a mobile device application software according to any one of the above.

The present invention also provides a system for interactively participating in a show format according to any one of the above, the system comprising:
a database connected to a network, the database containing information on properties in the show format; and
at least one electronic device operable by a viewer and connectable to the network, wherein the electronic device can run an application software for allowing the viewer to enter a property identification means of a selected property, and wherein the application software provides information on the selected property from the database.

Preferably, the show format is a countdown and the property identification means comprises the position number of the selected property in the countdown.

Preferably, the application software can run in real time with the show format, and the property identification means comprises a button with a select function which can be actuated by the user.

Preferably, the application software provides viewer feedback to the database.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a table illustratively showing the allocated time slot for each featured property in accordance with a preferred embodiment of the present invention.

FIG. 2 illustratively shows a screenshot of the television show in accordance with the preferred embodiment.

FIG. 3 is a schematic diagram of an interactive television program system according to the present invention.

### DETAILED DESCRIPTION OF THE INVENTION

It should be noted in the following description that like or the same reference numerals in different embodiments denote the same or similar features.

General Television Show Format

The television show format according to the preferred embodiment will feature one hundred (100) residential properties on the market for sale (either by set price or auction) that will be having their first scheduled “open for inspection” time on the same day as the show airs.

The television show format is a ‘countdown’ starting with the least expensive property featured that day as property number 100 and finishes with the most expensive featured property as property number 1. The length of the show will be determined by the size of the market but for a big market like Sydney, the show will be around two hours. The television show will have a fast moving format and a style that will combine a traditional morning show with a financial market broadcast.

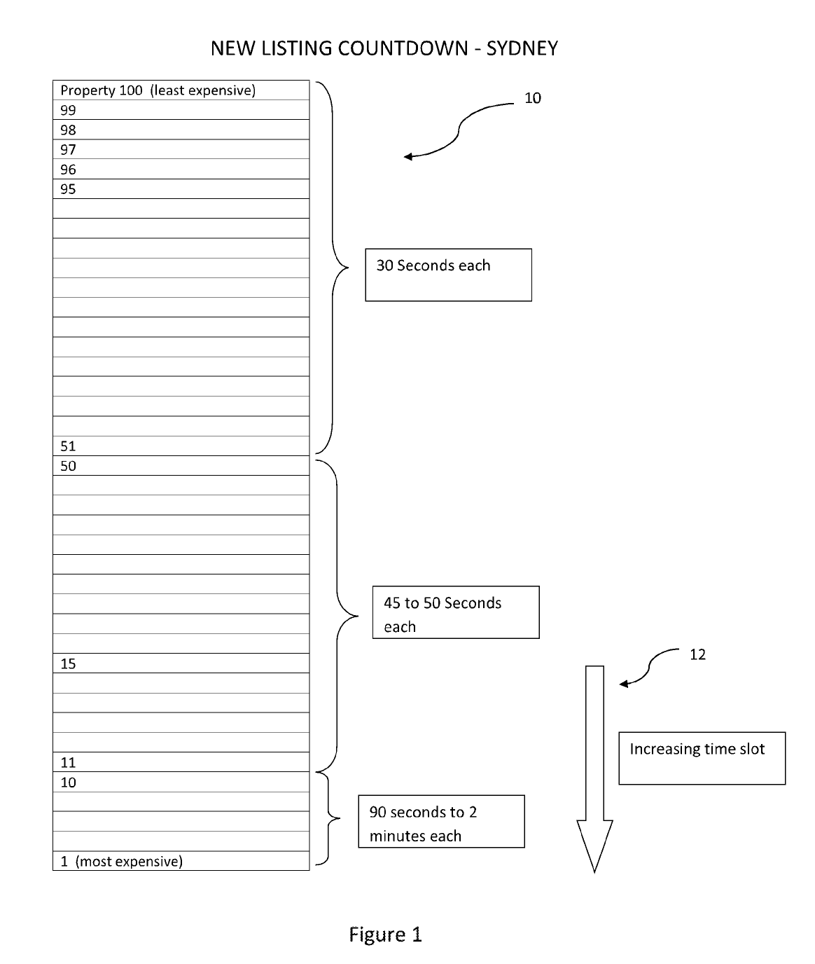

FIG. 1 shows a table 10 illustratively showing the allocated time slot for each featured property. Properties numbered 100 to 51 will have around 30 seconds of airtime each. In one embodiment, properties numbered 50 to 11 will be provided with 45 to 50 seconds each with properties numbered 10 to 1 being provided with 90 seconds to 120 seconds each. In another embodiment, a selected section of properties, for example properties numbered 15 to 1 or properties numbered 10 to 1 can be provided with an increasing allocated time slot as indicated by arrow 12. For example, each successive more expensive (lower number property) can be provided an additional 20 seconds from the previous property shown.

Information Data Shown

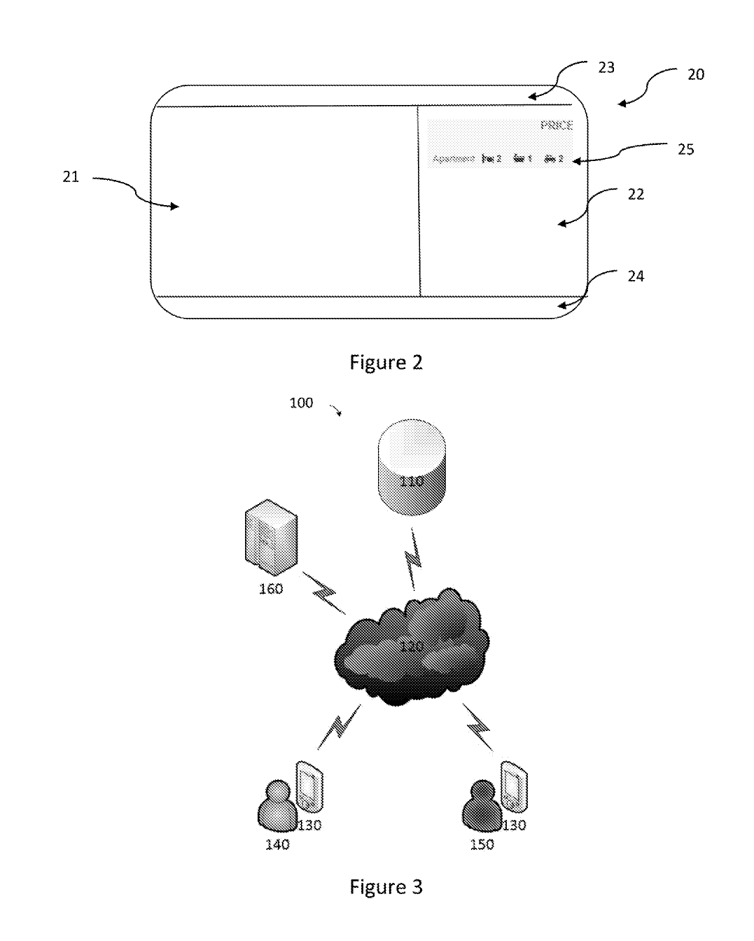

The show will be heavy on graphics based data, with information on properties being shown in a number of formats as shown in FIG. 2 which illustratively shows a screenshot 20 of the show. The property can be shown in the main screen 21, property information in a sliding graphics from the side box 22, superimposed on the images or video shown of the property, other information in a news ticker band 23 on the top of the page (for property auction times that day—as further described below) and other information in a news ticker band 24 on the bottom of the page (for other non-featured open for inspection properties—as further described below).

For each of the 100 properties, there will be displayed on the screen photos of the property, the address, the price guide, in some cases a video of the property, the time of the ‘Open for Inspection’, the name and contact details of the real estate agent, a photo or video of the real estate agent, the expected rental return, auction date, property trends in that suburb and other relevant facts.

Information shown for each property can include a quick standard set of ‘Fast Facts’ 25 presented as text, graphics or a combination of both which includes property address, property type (house, townhouse, apartment), number of bedrooms, bathrooms and car parking spaces.

The show will also mention properties up for auction that day that may have been featured in a previous show, as well as a listing of other (non-featured) properties that are open for inspection or up for auction that day which are not featured in the countdown. These are further described below.

Show Airing Time

It is envisaged that the show will air early in the morning, with a start time of between 6 am and 8 am to allow potential open for inspection viewers and auction bidders time to view the properties in the television show and plan which properties they intend to inspect or bid on. Alternatively, the show can be aired during primetime or a later timeslot of the night before the open for inspection/auction day to again provide potential viewers and buyers time to research the properties and plan their day.

The show can also be shown at both the night before and early in the morning of the open for inspection/auction day, with sections of the show also being available online.

Hosts and Panelists

The show will be hosted by a real estate doyen (a prominent person in the real estate industry) or a well known celebrity with real estate knowledge. The host will be supported by a panel of four real estate experts (the panelists). Each panelist will have several years of professional real estate experience.

The four panelists will be regulars of the show and represent a geographic spread of the market being discussed. For example, in the Sydney market, a respective panellist may represent each of the Sydney CBD and eastern suburbs, southern suburbs, northern suburbs and the western suburbs. Alternatively, two panellists may focus on the Sydney CBD and close surrounding suburbs, with one panellist focussing on apartments and the other panellist focussing on standing property such as townhouses and houses. The other two panelists may then focus on a similar split of properties in the other suburbs.

The host and panelists will not repeat everything displayed on the screen but will talk about the highlights of each property—for example if the rental return was particularly good, and two or three other key features of the property such as a swimming pool, kids play area, a feature kitchen, theatre room, distance to school, transport and others.

In the days prior to the show, each panelist will have visited 25 properties each and met the selling agent so they can talk with authority about that property. As the show moves from one property to another, each property will be introduced by the particular panelist who visited the property but the other panelists and the host would also contribute commentary along the way and ask one or two specific questions about the property highlights and features.

A TV camera crew will attend some of the panelists visits to the properties and a 30 second to one minute montage of the panelists shaking hands with various real estate agents and walking through their properties will be shown at the beginning, midway and towards the end of the show.

Some agents do not like to give a “price range” so it will be up to the panelists to get a guide from the real estate agent or to provide an estimate themselves to then help compile the countdown in order from 100 to 1.

As the countdown show continues and gets closer to property number 1, the show will spend more show time on the more expensive properties. As the show moves towards property number 1 a sense of anticipation would be fostered. Just prior to property number 1, the show will display on the screen the entire list from property number 100 to property number 2 in a rolling screen format with just the very basic details i.e. address, price range and time of the Open for Inspection. This would take around two minutes but will be necessary as not that many people will have watched the entire show. It will also add to the excitement of unveiling property number 1. The show will spend around three minutes featuring the showcase property number 1.

The location of the show would ideally be physically within property number 1 being marketed that week. This would give the most expensive property maximum exposure. If the vendors wanted to be introduced on TV it would add more color. Alternatively, one or more of the panelists can be located at one of the other featured properties if there was something particularly special about that property although not being the most expensive (e.g. designed by well known architect or unusual view or location). At the conclusion of the show the host would encourage viewers to get out and look at the properties that have just come onto the market.

Auctions for that Day

The one day more important than an ‘Open for Inspection’ day is the day of auction. Real estate agents and vendors want auctions to be well attended to build atmosphere. As such, TV exposure on the day of auction will help.

Around 30% of the properties featured in the countdown will be auctioned around five weeks later. Most of the more expensive properties will likely go to auction.

The countdown show will be sectioned into bands of 10 ‘open for inspection’ properties being displayed together—for example, positions no. 70 to no. 61 has properties from $450,000 to $600,000. At the commencement of each band (i.e. immediately after a commercial break) will be a short display of all properties that have been featured in this particular band on previous shows and which on the day of broadcast are going to auction. There will likely be between two and five properties on each band but the number of properties may increase as the asking price increases. Only the address and time of the location will be displayed very quickly, and optionally the property fast facts. The exception can be a previously shown top 20 or top 10 property which will have a five second visual display for each property.

Other Open for Inspection and Auction Listings

There are far more than 100 new listings in Sydney each week. Properties that are not featured on the countdown show will have their address and the time of the ‘Open for Inspection’ running across the bottom of the screen as a news ticker 24. In this manner, every property new to market that day will be promoted. Properties that are scheduled for auction that day will have their address and the time of the auction running across the top of the screen also as a news ticker 23. Again, every property being auctioned that day will get at least a mention on the show.

Viewer Information by Mobile Device (Smartphone or Tablet Computer) App

Viewers will be able to obtain information on the properties shown in the television show via the associated mobile device (smartphone or tablet computer) application software (App). The App will have four functions. Often a day dedicated to looking at property is disorganized and stressful. The App will orderly manage the day and maximize the chances of it being fruitful for users.

Function 1: TODAY'S OPEN FOR INSPECTIONS

The first feature is a list of every ‘Open for Inspection’ property listed that day (whether featured in the countdown show or not). The App will carry more information about each property than the TV show. If the ‘Open for Inspection’ property was featured in the countdown show that day, the App will allow the user to simply input the number of the property in the countdown and immediately arrive at a full App display of the property. ‘Open for Inspection’ properties that were not featured in the countdown show will have the same data accessible to the user via typing in the address or by scrolling through the entire list. Alternatively, each property not featured in the countdown show can be provided with a code such as A201 which the user will then enter into the App to access the property details. Properties can also be searched for via suburb and/or price range.

In another possible alternative, the App may function in ‘real time’ with the property countdown show. The App user watching the show will launch the app whilst watching the show. The App will then display the present real time countdown number on the smartphone or mobile tablet screen of the property number being shown in the television show. The user will then press an “I'm Interested” button in the mobile device screen when he/she is interested in the property being shown. The details of the properties of interest will then be saved in the background and shown only to the user when requested.

Function 2: TODAY'S AUCTIONS

The second part of the App will be “TODAY'S AUCTIONS” which will list all auctions times and details for that day regardless of whether or not the property was shown in the television show. Every property being auctioned that day will be featured in a long list of single line entries with the address and time of the auction. Details about the property could be accessed via typing in the address or by scrolling. Today's auction properties can also be searched via suburb and/or price range.

The App may also function in ‘real time’ with the property countdown show for the Auctions feature. The App user watching the show will launch the app whilst watching the show. The App will then display the present real time countdown number on the smartphone or mobile tablet screen of the property number being shown in the television show. The user will then press an “I'm Interested” button in the mobile device screen when he/she is interested in the property being shown which is up for auction.

The App is connected to a system server which provides real time feedback to the television show hosts, producers and/or real estate agents of various information, such as number of viewers interested. In this manner, the television show hosts can comment in real time regarding buyer interest on the property. Buyer interest and other real time feedback information can be shown as numbers or graphs, such as a moving line or bar graph. The App may also allow users to send quick questions to the hosts which they may be able to answer quickly live on air. The App may also request viewers register their details and allow the user to immediately send their details to the agent for contacting them about the property.

Function 3: TODAY'S ITINERARY

This is a one-day diary that allows the user to populate it with potential visits to both ‘Open for Inspections’ and ‘Auctions’ properties that are selected. The Itinerary gets properties added to it via either inputting the countdown number of the property featured in the television show (or those added via the “I'm interested button) or by finding a property from one of the other two sections of the App. Once the user has arrived at the property's detailed App page they simply press an ADD button and the time and address of the property details are automatically pre-populated into the Itinerary.

The TODAY'S ITINERARY display will divide the coming day into quarter hour intervals between 9 am and 4 pm in a simple single scroll page. The entry gives the start and end time and the address of the ‘Open for Inspection’ and the start time of ‘Auctions’ properties It advises if there are clashes between the times of the selected properties and one click or swipe deletes the property of least interest. If feasible, the App advises the road distance or estimated distance between suburbs of the adjacent scheduled properties. Further, the itinerary can be transferred to a mobile device map or navigation software App which will then provide directions to the user on how to get from one property to the next in the itinerary.

Function 4: CONTACT AGENT

This feature allows the user in one or two clicks to send a pre-written auto message to the selling agent of a particular property requesting a phone call, e-brochure and/or contract for sale of the viewed property.

The App will be available to users for free. A website may also be provided listing the countdown properties from the previous week.

Viewer Information by SMS Service

Alternatively, viewers will be able to request and receive more information on a particular property by sending a text message to a designated sms number with the property countdown number. For example, the format can be “countdown Sydney #23”, with the “#23” representing the countdown property number. An automatic sms reply service will then send the information of property number 23 back to the viewer's phone.

It may also be possible for the viewer to request information on multiple properties via sms with the format “countdown Sydney #23 #20 #15” and the automatic reply sms service sending information on property numbers 23, 20 and 15 back to the viewer.

Supplementary Information Breaks

A commercial break can be provided prior to properties: 85, 70, 60, 50, 42, 35, 30, 25, 20, 15, 10, 5, and 1. In the 30 seconds or so prior to a commercial break, the television show will have a “Regular Guest” or “Feature Guest” who is an industry professional who will give a report about property related news or a general tip about property related matters. The ‘Guests’ can be a:
Mortgage broker for example discussing “Best Fixed Rates in the market.”
Legal professional for example discussing “What to look for in a Contract of Sale.”
Economist for example discussing “Expected interest rate moves from Reserve Bank.”
Real estate developer for example discussing “A new 300 unit development has been approved in Erskineville.”
Accountant for example discussing “How to Claim Depreciation on an investment property”
An auctioneer for example discussing “Tips for attending auctions.”
Builder for example discussing “How to increase the value of property for a low cost.”
Architect for example discussing “A new trend in property design.”
Interior designer for example discussing “Tips for Vendors.”
Sydney trend analyst reporter for example discussing “Sutherland Shire is outperforming the rest of Sydney.”
Australia-wide trend analyst reporter for example discussing “Perth prices are down but Darwin is up and Hobart rents are improving.”
International property market trend analyst reporter for example discussing “South African property has risen 18% in the past year but Canadian property has declined. 7%.”
Presenter discussing a review of a particular suburb for example discussing “Spotlight on Paddington.”
Presenter discussing a look back at two or three properties featured in previous shows which have sold.

Many of the “Guests” can be screened Australia-wide (i.e. mortgages, accountant, builder etc.) though others will be market specific to a geographical area.

The ‘Guests’ will make the television show implicitly a respected property news show. The television show can become the central hub of new listings and property news

The preferred embodiment thus provides a television show which shows:
1. A top 100 countdown.
2. New listings only. The 100 properties will all be having their first ‘Open for Inspection’ that very day.
3. Displaying a significant volume of real estate on TV limited to a specific geographical market.

The show can be titled “NEW LISTINGS COUNTDOWN—SYDNEY” (or whatever market the geographic location the show is in).” The show format can be used in regional markets in Australia and around the world.

Whilst preferred embodiments of the present invention have been described, it will be apparent to skilled persons that modifications can be made to the embodiments described. For example, the show format can alternatively be broadcast via other means than television, including radio, by live streaming over the internet or via the smartphone or tablet app itself via a telephone or wireless network. Also, the format can be used in a printed publication such as newspaper.

Further, the show format can also be used for rental properties and commercial properties. Also, the show countdown format can also be used for other properties or items for sale such as vehicles, furniture, fashion items and antique items whether for sale or for auction.

The open for inspection properties in the countdown can also have their specified inspection times over more than one day, for example a Saturday and a Sunday. In this manner, a show broadcast on Saturday morning can cover open for inspection properties over the entire weekend, and a show on late Sunday evening for example can cover open for inspection properties over the Monday to Friday week.

The show format can also be interactive. For example, the number of viewers indicating interest in a particular property via the App can be shown in real time during the show at which the show and panellists can provide immediate comment.

Referring to FIG. 3, the interactive system 100 according to the present invention is described. The system 100 includes a database 110 connected to a network 120. The system 100 further includes a plurality of electronic devices 130, each running the television show software application (app) and each operated by either a viewer 140 or real estate agent 150. The electronic devices 130 are each connected to the network 120, and thereby to the database 110. A backend portal 160 is also included in the system 10 to process feedback information, and requests for information received by the software application running on each electronic device 130, and to also control and operate the database 110 as necessary.

Each of the electronic devices 130 is operable to connect to the network 120 via one or more means, including a wired network connection such as Ethernet™ or USB, a wireless connection such as Wi-Fi or Bluetooth™, a mobile telecommunications connection such as 3G, 4G, LTE, HSPA, GSM, CDMA, and the like, and/or other networked connections.

The database 110 stores therein information on the properties shown or mentioned in the television show. The database 110 is accessible by the real estate agent 150 through the electronic device 130 to create and update records stored therein that correspond to properties for which the real estate agent 150 is responsible. For example, the agent 150 will be allowed to alter the asking price or viewing times for the properties he/she is responsible for. Further, the database 110 is accessible either directly or indirectly through the backend portal 160 by the viewer 140 to search for agents 150 meeting one or more criteria. Access to the database 110 by both the agent 150 and the viewer 140 is effected by the application system 100 running on respective electronic devices 130.

It is also apparent that instead of being a countdown, the show can instead be a count up.

1. A method of providing show format comprising the steps of:
providing a listing of a predetermined number of properties on the market that are scheduled to have a public inspection time over a predetermined period, the listing beginning with the least expensive featured property and ending with the most expensive featured property.

2. The show format method of claim 1 wherein the listing is comprises a countdown of ‘x’ number of properties beginning with the least expensive featured property designated as ‘property number x’ in the countdown and ending with the most expensive featured property as ‘property number V.

3. The show format method of claim 1, further comprising the step of: broadcasting the listing via at least one of television, radio, telephone network, wireless network or the internet.

4. The method of claim 1 wherein the properties are selected from at one of a group consisting of real estate properties, commercial properties, vehicles, fashion items, furniture, and antique items.

5-8. (canceled)

9. The method of claim 1 wherein the public inspection time is an open for inspection time for the property.

10. The method of claim 1 wherein the predetermined period is selected from at least one of a group consisting of: a time section of a day, one day, one weekend, and consecutive days of a week.

11-15. (canceled)

16. The method of claim 1 wherein the predetermined period is selected from at least one of a group consisting of: a broadcast day and a day after the broadcast day.

17. (canceled)

18. The method of claim 1, further comprising the step of: providing an allocated time slot to show each featured property for at least 30 seconds.

19. (canceled)

20. The method of claim 18 wherein an allocated time slot for more expensive properties is greater than less expensive properties.

21. The method of claim 1 wherein the properties in the listing are real estate properties on the market for sale or auction, the method further comprising the step of providing a news ticker listing property auction times or open for inspection times for the predetermined period.

22. (canceled)

23. The method of claim 1 wherein the properties in the listing are real estate properties and in the allocated time slot for each of property, the method further comprising: displaying information on the property comprising one or more of photos of the property, the address, the price guide, a video of the property, the time of the Open for Inspection’, the name and contact details of the real estate agent, a photo or video of the real estate agent, the expected rental return, auction date, property trends in that suburb and other relevant facts.

24. The method of claim 1 wherein the properties in the listing are real estate properties, the method further comprising: providing information for each property being a standard set of facts presented as text, graphics or a combination of both which includes property address, property type, number of bedrooms, bathrooms and car parking spaces and the price guide.

25-31. (canceled)

32. The method of claim 2 wherein prior to property number 1, the method comprising the step of displaying an entire list from property number x to property number 2 in a rolling screen format with basic details for each property.

33. (canceled)

34. The method of claim 2, further comprising the steps of: sectioning a countdown into price bands of open for inspection properties being displayed together and displaying properties in each respective price band.

35. (canceled)

36. The method of claim 1 wherein the show format is limited to real estate properties having their first open for inspection in the predetermined period in a specific geographical market.

37. (canceled)

38. A system for providing information on a property shown in according to the method of claim 1, the system comprising:
means for a user to enter a property identification means of a selected property into an application software; and
wherein the application software provides information on the selected property.

39. The system of claim 38 wherein a countdown and the property identification means comprises the position number of the selected property in the countdown.

40. The system of claim 38 wherein the application software provides at least one of a group consisting of: a list of open for inspection selected properties, and a list of selected properties scheduled for auction in the predetermined period.

41. (canceled)

42. The system of claim 38 wherein the software can run in real time, and the property identification means comprises a button with a select function which can be actuated by the user.

43. (canceled)

44. The system of claim 38 wherein the application software provides a means for contacting the selling agent of the selected property.

45-62. (canceled)
